(19) United States
(12) Patent Application Publication
(10) Pub. No.: US 2015/0269511 A1
(43) Pub. Date: Sep. 24, 2015

(54) EXTENSIBLE FRAMEWORK FOR RESOURCE PROVIDER SERVICE AND QUOTA MANAGEMENT

(71) Applicant: MICROSOFT CORPORATION, Redmond, WA (US)

(72) Inventors: SATA BUSAYARAT, Redmond, WA (US); JAMEEL ADEDAYO GBAJABIAMILA, Redmond, WA (US); VLADIMIR GREGORY POGREBINSKY, Redmond, WA (US)

(73) Assignee: MICROSOFT CORPORATION, Redmond, WA (US)

(21) Appl. No.: 14/222,366

(22) Filed: Mar. 21, 2014

(51) Int. Cl. G06Q 10/06; G06F 9/54; G06Q 30/04

(52) U.S. Cl. CPC G06Q 10/06315; G06Q 30/04; G06F 9/546

(57) ABSTRACT

Methods, systems, and computer storage media for managing resource provider service quotas in a cloud-computing environment are provided. Embodiments of the present invention are directed to methods managing service quotas for resource provider services in a cloud-computing environment. Resource provider services may include virtual machines, websites, text messages and storage. Embodiments of the invention provide single, consistent and cohesive application programming interface to manage quotas across various resource provider services, administrators, billing applications and tenants. Options can be provided to administrators and tenants to adjust tenant plan subscriptions through adding additional resource provider services, creating subscriptions and deleting subscription. A quota management service using application programming interfaces provides feedback to the administrators and tenants on quota violations or inconsistencies with tenants or tenant plans.

### BACKGROUND

Large-scale networked systems in a cloud computing environment are commonplace systems employed in a variety of settings for running service applications and maintaining data for business and operational functions. For instance, a data center within an enterprise networked system may support operation of a variety of differing resource provider services (e.g., virtual machines, web applications, email services, search engine services, etc.) in a cloud computing environment. In a cloud computing environment where new types of resource provider services are added and removed from the environment at a rapid pace, it is difficult to manage and enforce quotas on the various types of resource provider services.

Furthermore, where there are multiple system administrators creating plans for tenants using of the various resource provider services in the cloud computing environment, quota enforcement and adjustment for the tenants across the various resource provider services cannot be solved using conventional techniques. Conventional techniques for quota management are designed specifically for particular types(s) of resource provider services and are not extensible to a cloud environment that is rapidly evolving. The distributed nature and unique structure of the cloud computing environments makes detecting quota violations by each of the large number of tenants difficult.

### SUMMARY

This Summary is provided to introduce concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention are directed to methods managing service quotas for resource provider services in a cloud-computing environment. Resource provider services may include virtual machines, websites, text messages and storage. Embodiments of the invention provide single, consistent and cohesive application programming interface to manage quotas across various resource provider services, administrators, billing applications and tenants. Options can be provided to administrators and tenants to adjust tenant plan subscriptions through adding additional resource provider services, creating subscriptions and deleting subscription. A quota management service using application programming interfaces provides feedback to the administrators and tenants on quota violations or inconsistencies with tenants or tenant plans. Embodiments of the present invention can be integrated with third party billing systems and services.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates substantially similar or identical items.

FIG. 1 is a block diagram of an exemplary computing environment suitable for use in implementing embodiments of the present invention;

FIG. 2 is a block diagram illustrating an architecture of an exemplary cloud-computing infrastructure, suitable for use in implementing embodiments of the present invention;

FIG. 3 is a block diagram illustrating the quota management service, suitable for use in implementing embodiments of the present invention, that is configured to manage tenant plan subscriptions and resource provider service allocation;

FIG. 4 is a table view of exemplary tenant subscriptions and related data, in the context of embodiments of the present invention;

FIG. 5 is a flow diagram of a method for creating subscription identifiers for tenant plan subscription in accordance with an embodiment of the present invention;

FIG. 6 is a flow diagram of a method for routing information for a tenant plan subscription in accordance with embodiments of the present invention;

FIG. 7 is a flow diagram of a method for routing tenant plan subscription information to resource provider services in accordance with embodiments of the present invention;

FIG. 8 is a flow diagram of a method for creating a real-time audit trail of resource provider services consumed by tenant plan subscriptions in accordance with an embodiment of the present invention;

FIG. 9 is a low diagram of a method for comparing consumption information for resource provider services against tenant plan subscriptions in accordance with a method of the present invention;

FIG. 10 is a graphical representation of an exemplary user interface (UI) for an administrator create and manage plans, in accordance with an embodiment of the present invention; and

FIG. 11 is a graphical representation of an exemplary user interface (UI) summarizing plans and quotas for exemplary plans for use by an administrator, in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

### Overview of Embodiments of the Invention

Embodiments of the present invention relate to methods, systems, and computer-storage media having computer-executable instructions embodied thereon that, when executed, perform methods in accordance with embodiments hereof, for management of resource provider service quotas in a cloud-computing infrastructure.

Multiple and varied implementations and embodiments are described below. Having briefly described an overview of embodiments of the present invention, the following section describes an operating environment suitable for implementing embodiments of the present invention. The following sections describe illustrative aspects of the techniques for carrying out embodiments of the present invention.

### Exemplary Operating Environment

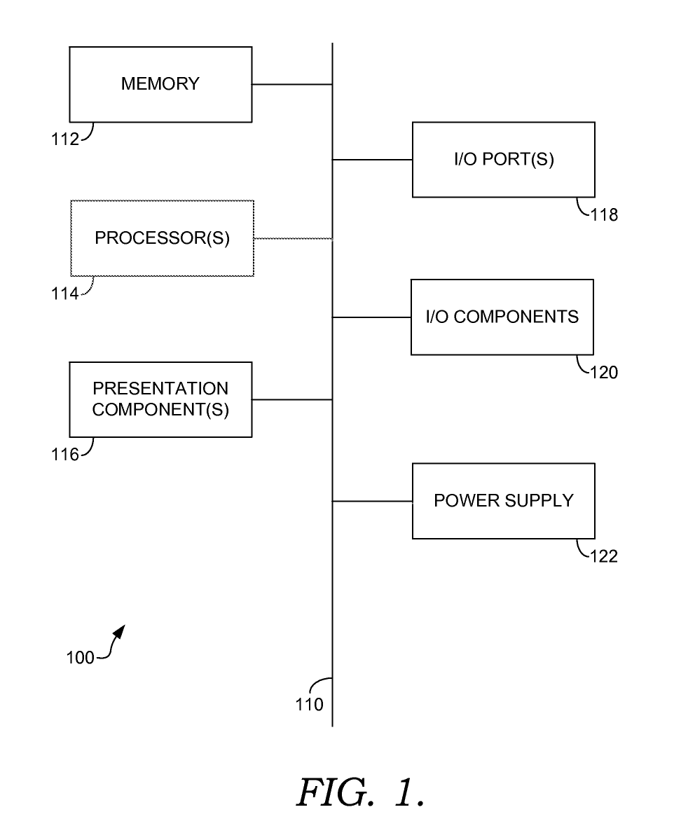

Referring to the drawings in general, and initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The invention may be practiced in a variety of system configurations, including hand-held devices, consumer electronics, general-purpose computers, specialty computing devices, etc. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device”.

Computing device 100 typically includes a variety of computer-readable media. Computer-readable media can be any available media that can be accessed by computing device 100 and includes both volatile and nonvolatile media, removable and nonremovable media. By way of example, and not limitation, computer-readable media may comprise computer storage media and communication media.

Computer storage media includes volatile and non-volatile, removable and non-removable media implemented in any method or technology for storage of information such as computer readable instructions, data structures, program modules, or other data. Computer storage media include, but are not limited to, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media typically embody computer-readable instructions, data structures, program modules, or other data in a modulated data signal, such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above should also be included within the scope of computer-readable media; however, as defined herein, computer storage media does not include communication media.

Memory 112 includes computer-storage media in the form of volatile and/or nonvolatile memory. The memory may be removable, nonremovable, or a combination thereof. Exemplary hardware devices include solid-state memory, hard drives, optical-disk drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

Ports 118 allow computing device 100 to be logically coupled to other devices including I/O components 120, some of which may be built in. Illustrative components include a microphone, joystick, game pad, satellite dish, scanner, printer, wireless device, etc.

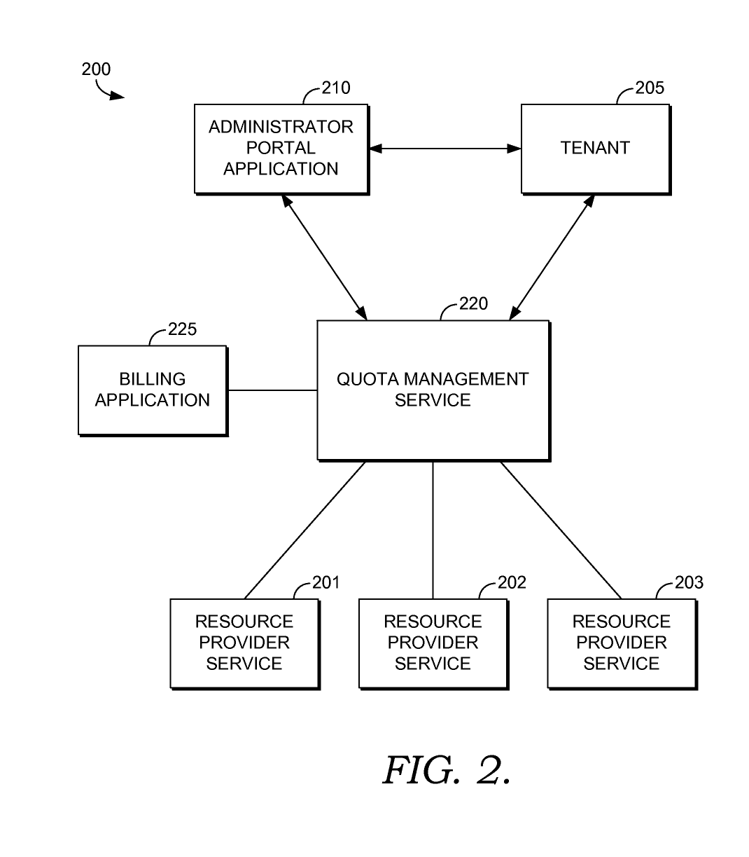

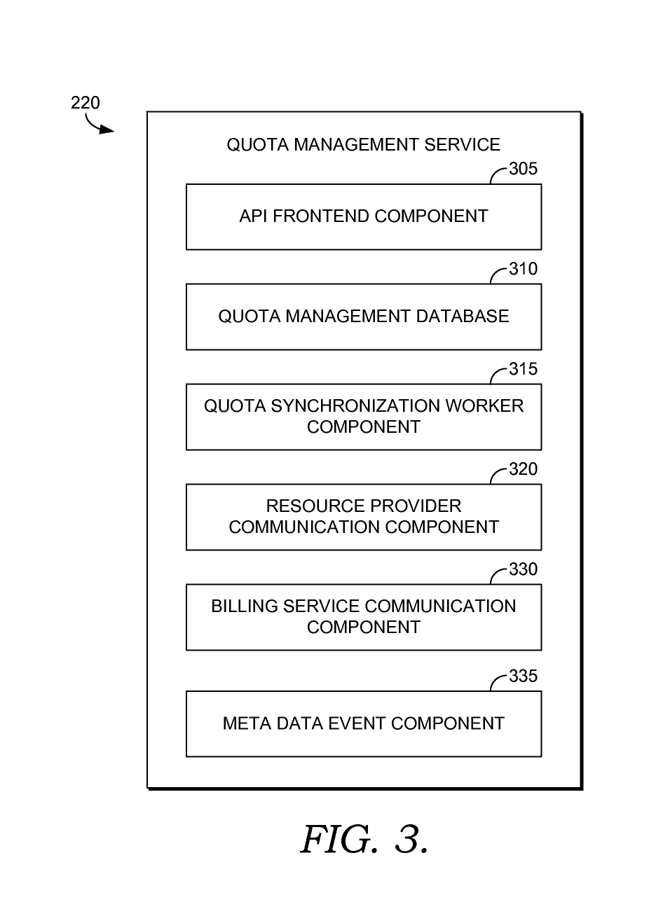

Turning now to FIG. 2 and FIG. 3, a block diagram illustrating architecture 200 of an exemplary cloud-computing infrastructure, suitable for use in implementing embodiments of the present invention, is shown. The cloud-computing infrastructure 220 includes quota management service 220 that is configured manage resource provider service quotas while communicating with tenants 205, administrator portal application 210, resource provider services 201-203 and billing application 225 in a cloud-computing infrastructure. In an exemplary embodiment, the quota management service 220 is provided for performing a method that manages resource provider services and enforces quotas. The detailed components of quota management service 220 are described in FIG. 3.

Further, it will be understood and appreciated that the architecture 200 of the cloud-computing infrastructure shown in FIG. 2 is merely an example of one suitable computing system environment and is not intended to suggest any limitation as to the scope of use or functionality of embodiments of the present invention. For instance, the cloud-computing infrastructure may be a hybrid cloud environment, public cloud, a private cloud or dedicated cloud. Neither should the cloud-computing infrastructure be interpreted as having any dependency or requirement related to any single component or combination of components illustrated therein. Further, although the various blocks of FIG. 2 are shown with lines for the sake of clarity, in reality, delineating various components is not so clear, and metaphorically, the lines would more accurately be grey and fuzzy. In addition, any number of nodes, virtual machines, data centers, role instances, or combinations thereof may be employed to achieve the desired functionality within the scope of embodiments of the present invention.

The architecture 200 of the cloud-computing infrastructure includes an enterprise data center (not shown) configured to host and/or support operation of resource provider services 201, 202 and 203. It will be appreciated that while resource provider services 201, 202 and 203 are hosted by a data center. Resource provider services could include virtual machines, website, text messages, data storage and servers. Servers and data storage are usable to execute computer operations. For examples, servers are used to execute applications of administrator, such as private cloud applications. In one embodiment, administrator configures the technology for an entity, such as a business enterprise.

As used herein, the phrase “virtual machine” is not meant to be limiting, and may refer to any software, application, operating system, or program that is executed by a processing unit. Further, the virtual machines may include processing capacity, storage locations, and other assets. It will be understood and appreciated that the resource provider services 201, 202 and 203 shown in FIG. 2 are merely an example of suitable parts to support the cloud computing environment and are not intended to suggest any limitation as to the scope of use or functionality of embodiments of the present invention.

A data center is also configured to host and/or support service applications. The phrase “service application,” as used herein, broadly refers to any software, or portions of software, that runs on top of, or accesses storage locations within, the data center. An exemplary service application that could be hosted is quota management service 220.

An on-premises private cloud-computing environment is a set of resource provider services such as hardware, networking, storage, services, applications, and interfaces owned and operated by an entity, such as an enterprise, for the use of its sub-entities, partners, employees and customers. An on-premises private cloud is controlled by an entity and is not available for public use. An on-premises private cloud may include a data center including resource provider services 201-203. A private cloud typically is located behind a firewall and not available for public use. In some embodiments, a private cloud can be created and managed by a third party for the use of the entity.

Embodiments of the present invention may also be utilized with a combination of a private cloud combined with the use of public cloud services where one or several touch points exist between the environments. The goal is to combine services and data from a variety of cloud models to create a unified, automated, and well-managed computing environment. For example, in a hybrid environment can use an on-premises data center of the private cloud and augment with resource provider services from the public cloud and vice versa. Embodiments of the present invention abstract the physical data center of a private enterprise or cloud such that both the private and public cloud can appear to work on the same network. A consistent platform is provided across private and public clouds such that administrators using administrator portal application 210 can provide and manage the resource provider services (private and public) for their tenants 205 (customers, employees, divisions and partners of the entity).

Administrators demand flexibility in a cloud computing environment to define plans, billing, services, cost, amounts quotas, and types (e.g., virtual machines vs. hardware). Using embodiments of the present invention, administrators utilize an administrator portal application 210 to configure and manage plans. Administrators can utilize embodiments of the present invention to create a cloud computing network to offer and manage plans and services to tenants 205 (or customers). A plan is a package comprising a list of offered resource provider services and quotas for the resource provider services. A service quota is a set of quotas for a particular resource provider service. A quota is the share or proportional part of a total resource provider service 201-203 that is allocated for a particular tenant plan subscription. The service quota for a subscription can be determined by a plan or add-on chosen by the tenant 205 and is used for quota synchronization.

Once configured by the administrator using the administrator portal application 210 a plan can be offered to tenants 205 with pricing information. A tenant 205 may be an employee, customer, partner, division or sub-entity of entity.

For example, an administrator may build, using the administrator portal application 210, a basic cloud environment hosting plan that includes two types of resource provider services 201-203, including three virtual machines and one website that can be purchased by a tenant 205. Furthermore an administrator using the administrator portal application 210 may build a premium plan hosting multiple resource provider services 201-203 including use of six virtual machines, three websites, text messages and one e-mail address.

A tenant portal allows a tenant 205 to choose plans, add resource provider services, and delete subscriptions as needed. Furthermore, a tenant portal for a tenant 205 to see what resource provider services they have and amount used. Tenants 205 can build and manage resource provider services locally in the private cloud or migrate to resource provider services on the public cloud through a single portal without require any change in coding.

Once a tenant 205 obtains a plan from an administrator portal application 210, the tenant 205 and the plan are registered with the quota management service 220. Entities, such as enterprises, typically track or charge divisions, partners or sub-entities based on usage of the entity's data center. Oftentimes this can be done as a charge back model or purchase model. Furthermore, customers of the entity may purchase usage of the entity's data center.

Once a plan is chosen by a tenant 205 the administrator portal application 210, communicates the tenant plan subscription information to quota management service 220. Quota management service 220 creates a subscription identifier for the tenant subscription plan. The subscription identifier for the tenant subscription plan is stored by the quota management service 220 and communicated to the administrator portal application 210, billing application 225 and resource provider services 201-203. The administrator portal application 210, quota management service 220, billing application 225 and resource provider services 201-203 can communicate with one another using a quota management session referencing the subscription identifier for managing the service quotas for the tenant plan subscription.

After purchase and establishment of the tenant subscription, the administrator using the administrator portal application 210 may offer additional resource provider services or larger service quotas (add-ons) to the tenant. The administrator portal application 210 the tenant may be offered additional resource provider services or additional service quotas (add-ons) for resource provider services 201-203. In one embodiment, add-ons may be offered to all tenants or tenants who subscribe to a particular resource provider service. In another embodiment, add-ons may be offered based on a live event notification for real time approval. For example, a tenant 205 may be exceeding use of virtual machines 201-203 for the basic plan purchased from the administrator portal application 210. A quota management synchronization worker 315 (FIG. 3) detects that an overage is about to occur, so in real time, can query the billing system 225 for cost information for any add-ons. Then using the administrator portal application 210 suggestions for add-ons for the tenant may be offered.

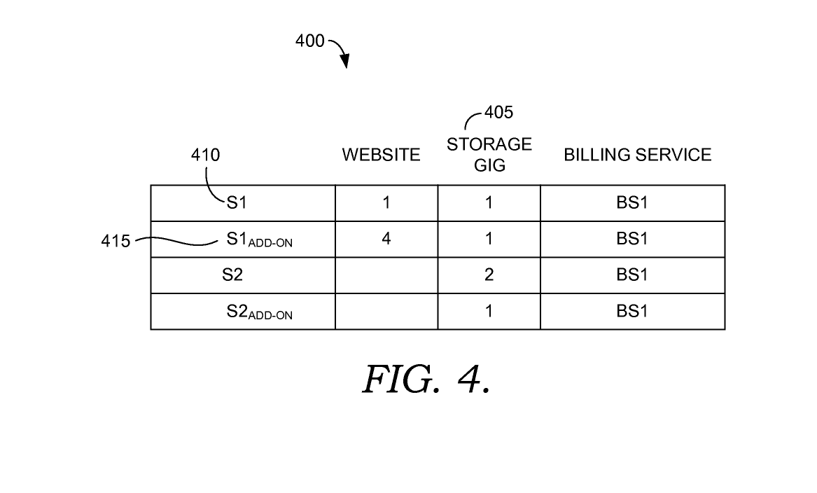

For example, with reference to FIG. 4, a data store 400 for quota management service 220 is shown. Data store 400 includes subscription identifiers 410 for tenant plan subscriptions along with the service quotas for the resource provider services 405 that are part of the tenant plan subscription. For example, subscription identifier S1 is for a tenant subscription plan that includes websites and storage. Any changes and/or add-ons to an individual tenant subscription plan are added to the same subscription number 410. The quota management service allows tenant subscription to be created, read, updated (with add-ons) and deleted (CRUD) as shown in exemplary FIG. 4. For example, as can be seen in FIG. 4 subscription S1, has received changes from the administrator portal application 210, thus the quota management service 220 has updated the subscription quota and added four (4) additional websites to the original tenant plan subscription of one (1) website for a total of five (5) websites.

In addition making changes (such as add-ons) to a single tenant plan subscription, the administrator, using the administrator portal application 210, may make a global update a plan and all subscriptions are updated. Using the administrator portal application 210, the administrator may add additional resource provider services or service quotas (add-ons) the administrator's basic plan and all subscriptions to the plan are updated with the add-ons. For example, the administrator may add resource provider services, change service quota changes or others changes to the administrator's basic plan. This information is communicated via the quota management layer to the quota management service 220. The quota management service 220 the updates all the tenant plan subscriptions for the administrator's basic plan with added resource provider services, quota changes or other changes made by the administrator.

In another embodiment, the administrator makes changes to add-ons that have been offered or made to plans. Using the administrator portal application 210, the administrator may make changes to the add-on and all subscriptions using that have the add-on are updated with the changes by the quota management service 220.

Furthermore, the quota management service 220 creates an audit trail of the usage, quota enforcement and offer of add-ons is created such that the billing system 225 when the tenant 205 is later billed for the plan and any add-ons can correctly formulate the invoice and provide a tracking system rebuild a historical trail. As discussed in more detail below, an event API will know about the potential add-on resource provider services that may be available based in the cloud-computing environment.

Embodiments of the present invention provide a single, consistent and cohesive application programming interface to manage quotas across various resource provider service types, administrators and tenants. Options can be provided to tenants 205 in real-time to adjust the tenant plan quotas as needed. The quota management service 220 provides feedback to the administrator portal application 210 and tenants 205 on quota violations or inconsistencies with tenants or tenant plans. Embodiments of the present invention can be integrated with third party billing systems and services 225.

New resource provider services 201-203 can be seamlessly added to the cloud computing environment 200 and offered to existing tenants 205 in real-time. The administrator using administrator portal application 210 can manage the quota of new resource provider services and existing resource provider services using the same quota management service 220. The quota management service 220 provides an interface to external billing systems 215, which will be notified of quota change events such as subscriptions, add-ons and deletions.

Referring to FIG. 3, the quota management service 220 may comprise a single software component or may be partitioned into a plurality of distinct software components that interact with each other in the cloud computing infrastructure. As illustrated in FIG. 3, the quota management service 220 is distributed into various software components. The quota management service 220 includes an API frontend component 305, quota management database 310, quota synchronization work component 315, resource provider service provider communication component 320, billing service communication component 330 and metadata event component 335.

The quota management API frontend component 305 exposes a set of unified subscription and quota management API to either administrator portal application 210 or tenants 205 via a tenant portal. The API frontend component 305 is stateless and can be replicated. API frontend component 305 allows administrators 210 to incrementally add new features to existing plans (add-ons), which in turn, will allow existing tenants 205 to access new resource provider services 201-203. This is accomplished by an asynchronous long-running API support that can modify N number of existing tenant plan subscriptions at the resource provider services 201-203 (the time required to update each subscription by different resource provider service providers also varies). The plan and add-ons are in the quota management messaging layer.

The quota management database 310 stores information about all entities in the system, administrators 210, tenants 205, resource provider services 201-203, their relationships configuration, commands and states. Quota management database 310 stores subscription identifiers, tenant plan subscription information, data regarding resource provider service and service quota information. Quota management database 310 also stores real-time quota data for audit-trail purpose.

Quota synchronization worker component 315 constantly monitors the state of each resource provider service 201-203, validates it against the configured quotas for each tenant plan subscription and reports violations and inconsistencies detected.

The resource provider service provider communication component 320 provides contracts to be implemented by resource provider services 201-203 such that the monitoring and reporting of quotas can be performed by the quota management service 220. Resource provider service provider communication component 320 is responsible for propagating quota information to the resource provider service providers 201-203 (via the internal quota API interface). Using information provided by resource provider service provider communication module 320, resource provider services 201-203 implement internal API contracts so the resource provider service quota of each resource provider service 201-203 can be managed by the quota management service 220 in a unified fashion. Each resource provider service 201-203 is registered with the quota management service 220 one time and then can receive and implement the internal API contracts so that resource provider service quota can be managed.

In one embodiment of the present invention, resource provider service provider communication component 320 provides asynchronous long-running application program interface (API). The asynchronous long-running API modifies N number of existing tenant plan subscriptions in each of the resource provider services 201-203 (the time required to update each subscription by different resource provider service providers also varies). The long-running API support keeps the complexity away from each resource provider service 201-203 and makes it easier for each resource provider service 201-203.

Billing service communication component 330 is responsible for notifying the billing service 215 on any quota changes so that tenants 205 will be billed accordingly. The billing service 215 may be an internal or external system to the data center. It also is integrated with the quota management service 220 via a one-time registration process utilizing the billing service communication module 330 and will be notified of any quota changes. The quota management service 220 treats this notification as first class and will not commit to further changes in tenant plan subscription unless it receives an acknowledgement from the billing application 225.

In yet another embodiment, live event notification is provided to the quota management service 220 to provide a full history of all metadata events over time and to be able to reconstruct a correct metadata snapshot at any time. Metadata event component 330 lists for events from the different resource provider services and stores these events for history maintenance to provide administrators and tenants live feed notification. The metadata event component 330 receives information from stateless worker synchronization components 315 who pull data from all resource provider service providers 201-203. The worker synchronization component 315 pulls usage information from resource provider service providers, sequentially and in an endless loop. The information is then stored in quota management database 310, such as SQL bulk copy operations. For every event, the quota management service 220 simultaneously and automatically registers the event data in the centralized storage 310 and delivers the live event notification to administrators 210 and/or tenants 205.

Administrator 210 creates plans that include resource provider services from the cloud computing environment 200. Administrator 210 loads a frontend resource provider service management API provided by Quota Management Service 220 using administrator portal to create plans and quotas to provide to resource provider service users 205. Plans may then be obtained by tenants 205. The plans and resource provider services utilized by the tenant's plan can be centrally managed and enforced by the Quota Management Service 220.

### Process Flows

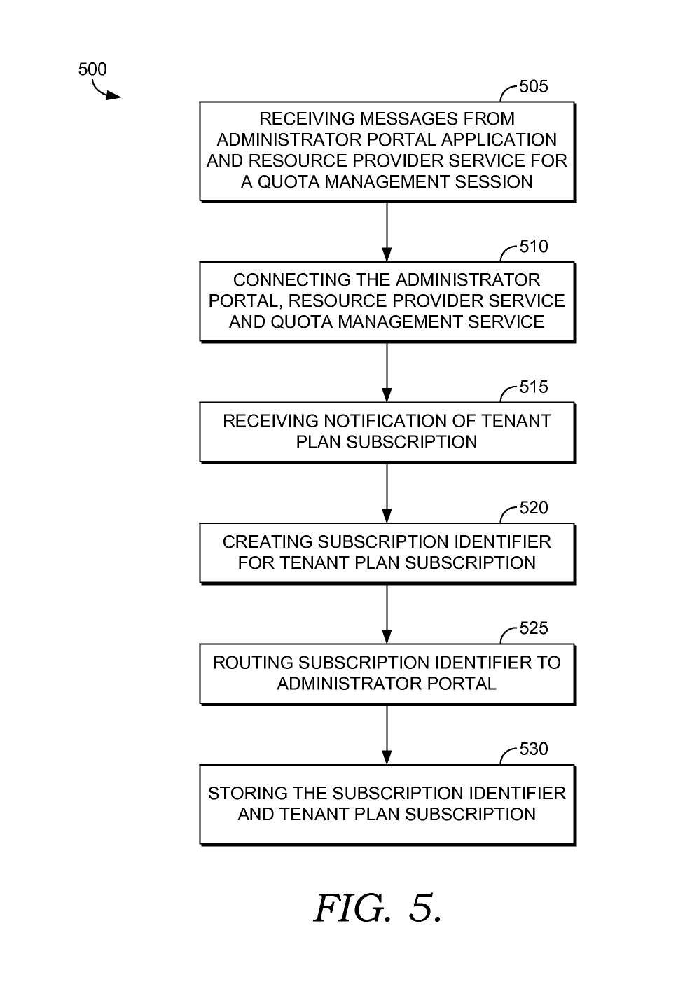

Exemplary methods for resource provider service quota management are described with reference to FIGS. 5-9. These exemplary methods can be described in the general context of computer executable instructions. Generally, computer executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network or a communication cloud. In a distributed computing environment, computer executable instructions may be located both in local and remote computer storage media, including memory storage devices.

The exemplary methods are illustrated as a collection of blocks in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be omitted from the methods without departing from the spirit and scope of the subject matter described herein. In the context of software, the blocks represent computer instructions that, when executed by one or more processors, perform the recited operations.

Turning to FIG. 5, a flow diagram showing an overall method 500 for creating a subscription identifier for a tenant plan subscription is shown, in accordance with an embodiment of the present invention. It should be noted that, although the terms “step” and/or “block” may be used herein to connote different elements of methods employed, the terms should not be interpreted as implying any particular order among or between various steps herein disclosed unless and except when the order of individual steps is explicitly described.

Initially, the method 500 receives messages from an administrator portal application and resource provider services for initialization of a quota management session at block 505. The administrator portal application and resource provider services register with the quota management service and at block 510 connect with the quota management service in order to start a quota management messaging session. The quota messaging service receives notification of one or more tenant plan subscriptions at block 515. At block 520, the quota management creates a subscription identifier for the tenant plan subscription and stores the subscription identifier and related tenant plan subscription information including amount of resource provider services to be allocated to the subscription.

At block 525, the subscription identifier is routed to the administrator portal application for the administrator portal application to subsequently communicate with the quota management service and resource provider services regarding quota management for the tenant plan subscription. Both the tenant administrator portal application and the quota management service store the subscription identifier and tenant plan subscription information at block 530.

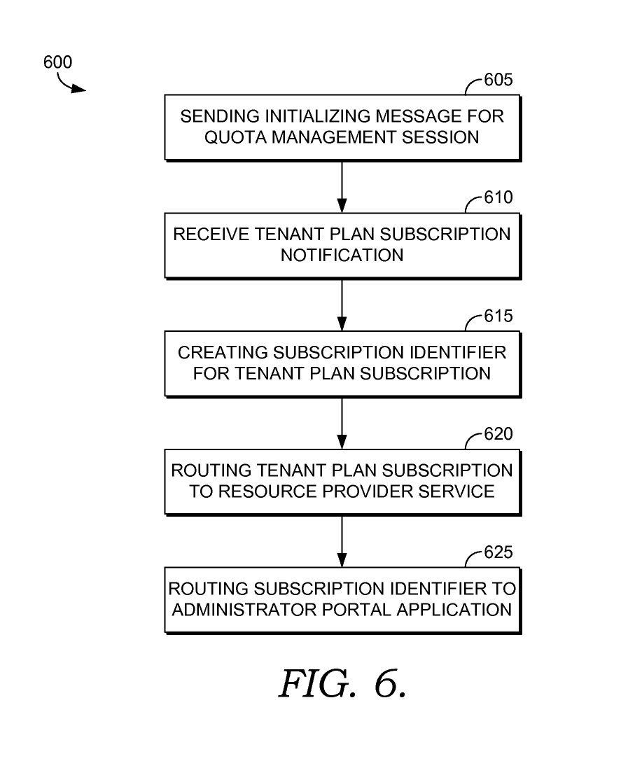

Referring next to FIG. 6, a method 600 for routing tenant plan subscription identifiers to a multiple resource provider services in a cloud-computing environment is shown. Initially, the method 600 receives messages from an administrator portal application and resource provider services for initialization of a quota management session at block 605. The administrator portal application and resource provider services register with the quota management service and connects with the quota management service in order to start a quota management messaging session. The quota messaging service receives notification of one or more tenant plan subscriptions at block 610. At block 615, the quota management creates a subscription identifier for the tenant plan subscription and stores the subscription identifier and related tenant plan subscription information including amount of resource provider services to be allocated to the subscription.

At block 620, the subscription identifier is routed via the quota management session to the resource provider services that are part of the tenant plan subscription. The resource provider services can subsequently use the subscription identifier to communicate with the quota management service for quota management of the tenant plan subscription.

At block 625, the subscription identifier is routed to the administrator portal application for the administrator portal application to subsequently communicate with the quota management service and resource provider services regarding quota management for the tenant plan subscription. The tenant administrator portal application, quota management service and resource provider services store the subscription identifier and tenant plan subscription information.

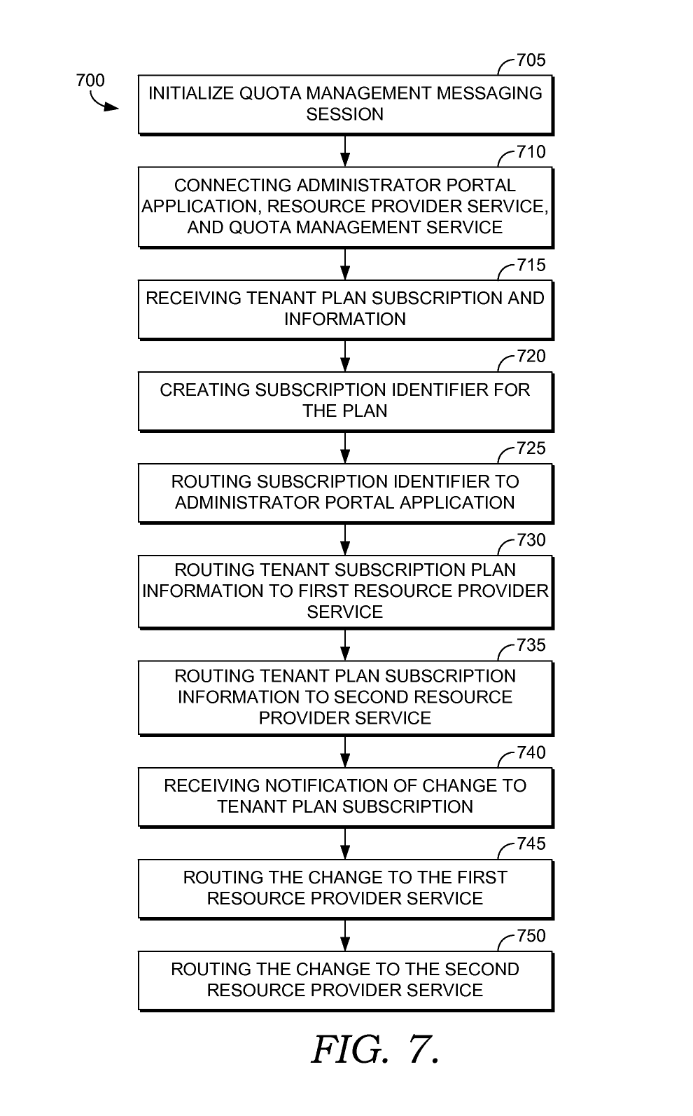

Referring next to FIG. 7, a method 700 for routing changes to a tenant plan subscription in a cloud-computing environment is shown. Initially, the method 700 receives messages from an administrator portal application and resource provider services for initialization of a quota management session at block 705. The administrator portal application and resource provider services register with the quota management service and connects with the quota management service in order to start a quota management messaging session at block 710. The quota messaging service receives notification of one or more tenant plan subscriptions at block 715. At block 720, the quota management creates a subscription identifier for the tenant plan subscription and stores the subscription identifier and related tenant plan subscription information including amount of resource provider services to be allocated to the subscription.

At block 725, the subscription identifier is routed to the administrator portal application for the administrator portal application to subsequently communicate with the quota management service and resource provider services regarding quota management for the tenant plan subscription. The tenant administrator portal application, quota management service and resource provider services store the subscription identifier and tenant plan subscription information.

At blocks 730 and 735, the subscription identifier is routed via the quota management session to the resource provider services that are part of the tenant plan subscription. The resource provider services can subsequently use the subscription identifier to communicate with the quota management service for quota management of the tenant plan subscription.

At block 740, changes to the tenant plan subscriptions are received by the quota management service from the administrator portal application. The changes may include adding additional resource provider services or proportion of resource provider services (add-ons), changes to the resource provider services or deletion of the tenant plan subscription. The quota management service updates the subscription identifier and tenant plan subscription to reflect the changes to the tenant's plan and keeps an audit trail of the changes to the tenant plan subscription.

At blocks 745 and 750, the changes to the tenant plan subscriptions are routed to the first and second resource provider services. Using the tenant subscription identifier, the quota management service notifies the resource provider services of changes to the tenant plan subscription so that there is proper allocation of resource provider services for the tenant plan subscription.

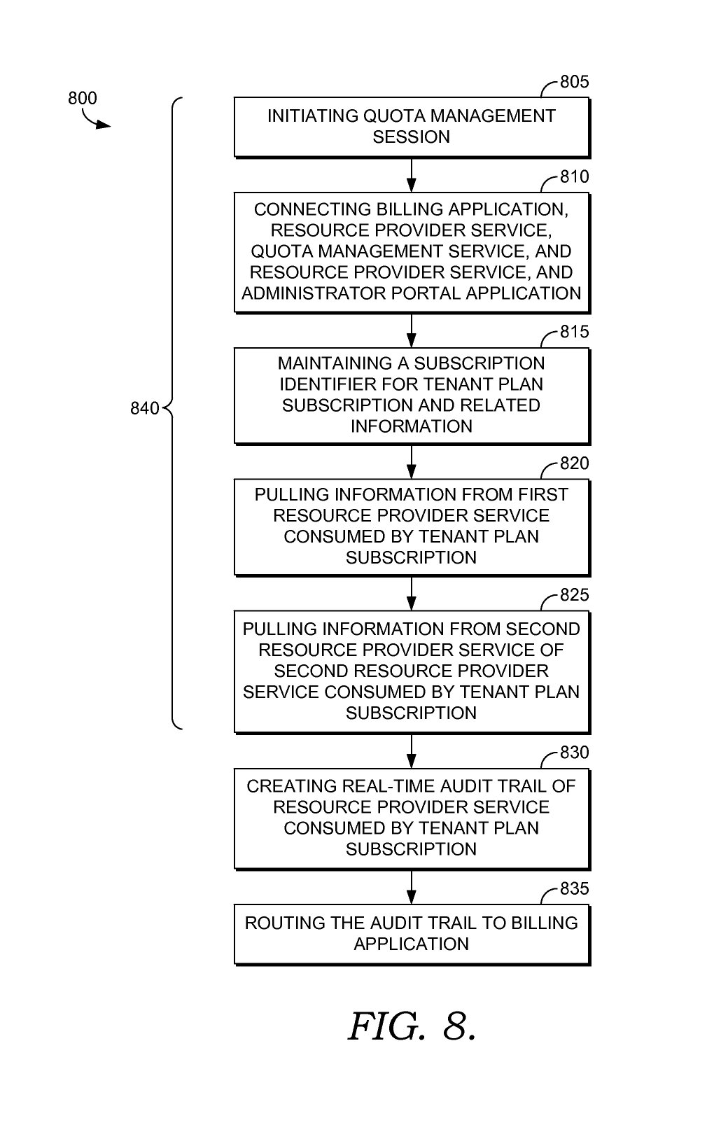

Referring next to FIG. 8, a method 800 for creating a real-time audit trail of resource provider services consumed by the tenant plan subscription in a cloud-computing environment is shown. Initially, the method 800 receives messages from an administrator portal application and resource provider services for initialization of a quota management session at block 805. The administrator portal application, billing application and resource provider services register with the quota management service and connect with the quota management service in order to start a quota management messaging session at block 810.

The quota messaging service receives and maintains subscription identifiers for tenant plan subscriptions at block 815. At block 820, the quota management service pulls information from a first resource provider service of the amount of the resource provider serviced consumed by the tenant plan subscription. At block 825, the quota management service pulls information from a second resource provider service of the amount of resource provider service consumed by the tenant plan subscription.

At block 830, the quota management service creates a real-time audit trail of the resource provider services consumed by the tenant plan subscription. The audit trail information is maintained in the quota management service and provides a redundant copy of the resource provider service utilization for the tenant subscription in case it is needed by the billing service due to a data loss.

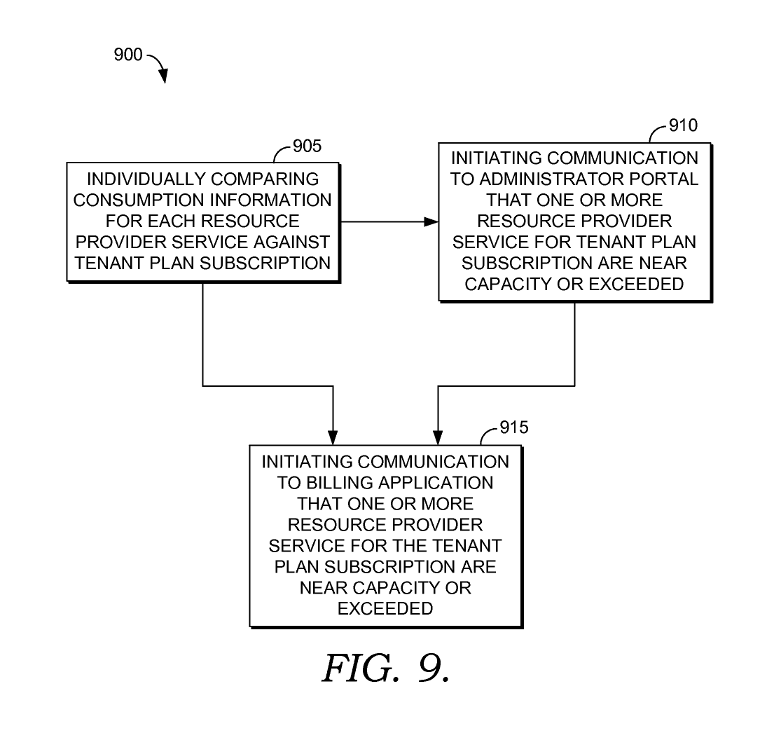

Referring next to FIG. 9, the consumption information obtained in method 800 can be utilized to individually compare the consumption information for each resource provider service against the tenant plan subscription at block 905. At block 910, if it is determined that the tenant plan subscription is at or near capacity for one or more resource provider services, a notification is sent via the quota management session to the administrator portal application at block 910. Recommendations of additional resource provider services can be made by the quota management service and sent to the administrator portal application for suggesting add-on resource provider services for the tenant plan subscription. In block 915, a communication to the billing application is sent via the quota management session to the administrator portal application at block 915. If recommendations of additional resource provider services or add-ons for the tenant plan subscription have been made, the billing application can provide real-time cost information to the administrator portal application such that the tenant can review the cost information for adding resource provider services to the tenant plan subscription.

Any of the acts of any of the methods described herein may be implemented at least partially by a processor or other electronic device based on instructions stored on one or more computer-readable media.

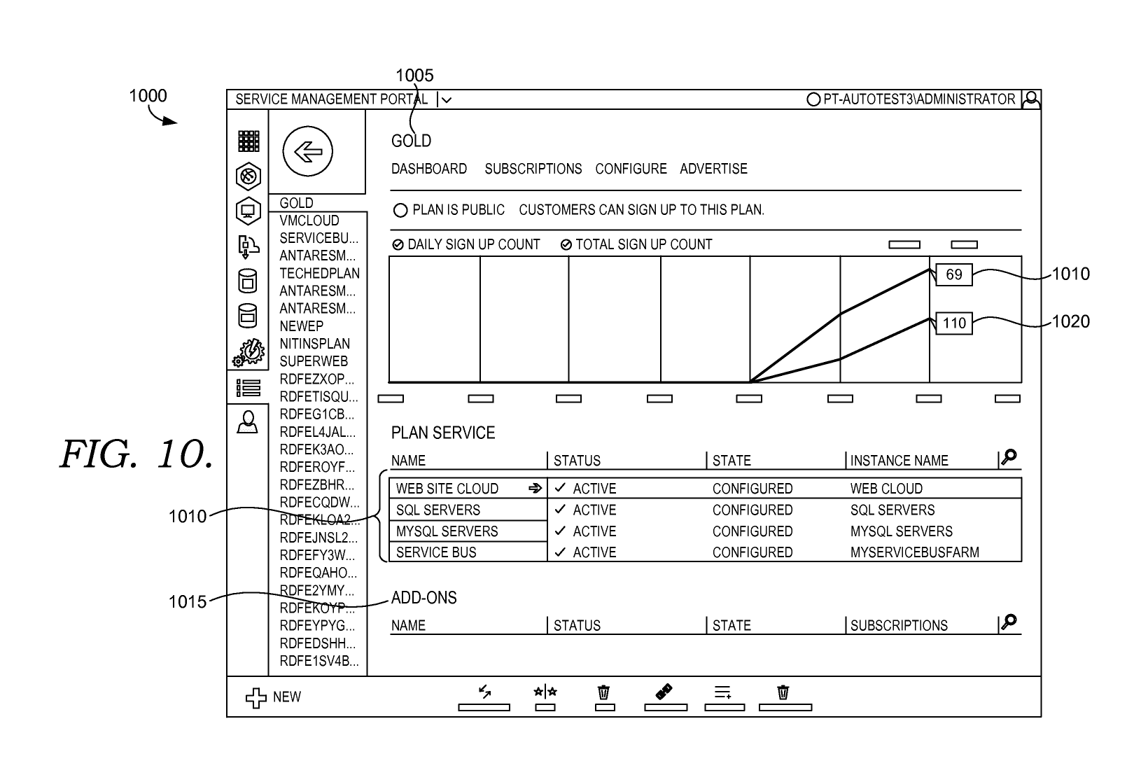

With reference to FIG. 10, a graphical user interface 1000 for the administrator portal application for use in a cloud-computing environment is shown. The user interface 100 shows a plan 1005 created by an administrator. The types of resource provider services 1010 that are included in the plan are listed as well as any additional resource provider services 1015 or services that could be added to the plan by a tenant. The user interface displays to the administrator the total number of tenants subscribing to the plan 1005 on a display 1010 and total 1020 basis such that an administrator can view how well the plan is being purchased by tenants.

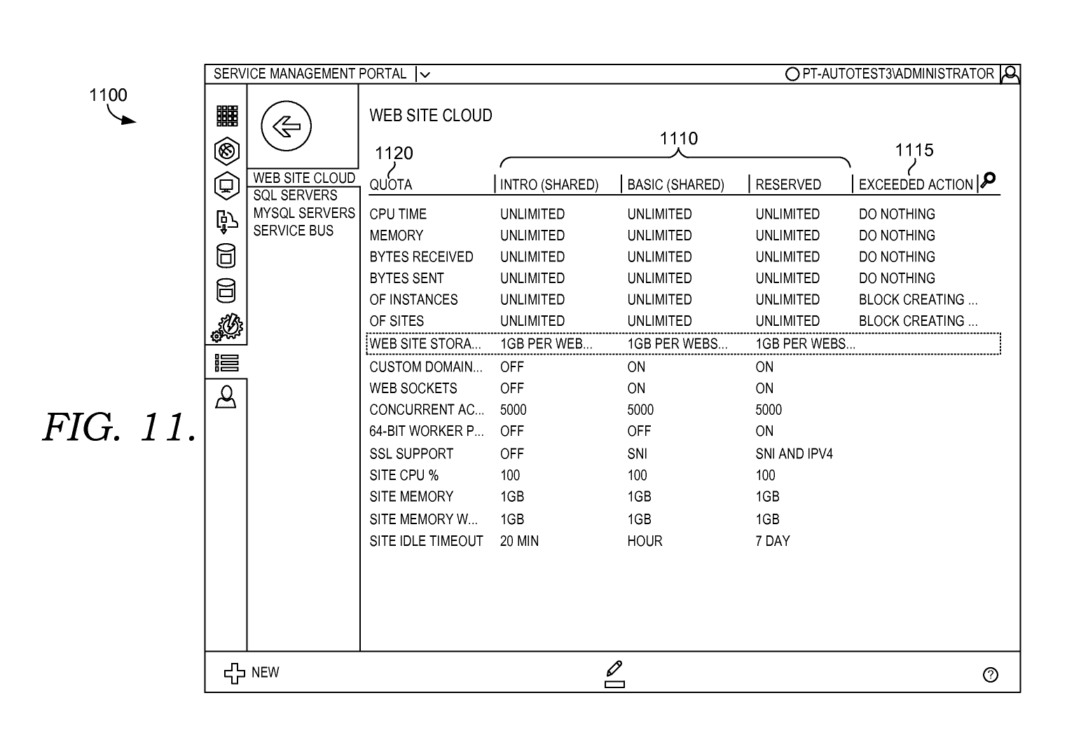

FIG. 11 shows a screenshot of a quota configuration user interface 1100 for the administrator portal application for use in a cloud-computing environment. The user interface 1100 shows various plan types 1110, along with quota information 1120 for each of the plan types 1110. Additional, the administrator portal application displays on the user interface 1100 whether the plan has exceeded its service quotas 1115 and what action, if any should be undertaken by the administrator.

Although the invention has been described in language specific to structural features and/or methodological acts, it is to be understood that the invention is not necessarily limited to the specific features or acts described. Rather, the specific features and acts are disclosed as exemplary forms of implementing the invention. That is, embodiments of the present invention have been described in relation to particular embodiments, which are intended in all respects to be illustrative rather than restrictive. Alternative embodiments will become apparent to those of ordinary skill in the art to which embodiments of the present invention pertain without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer storage media having computer-executable instructions embodied thereon that, when executed, perform a method for managing resource provider service quotas within a cloud-computing infrastructure, the method comprising:
receiving messages from an administrator portal application and resource provider services for a quota management messaging session between an administrator portal application and resource provider services, the quota management session automatically pairs the administrator portal application, the resource provider services and a quota management service based on a quota management messaging layer that facilitates communication between the administrator portal application, the resource provider services and the quota management service;
connecting the administrator portal application, the resource provider services and the quota management service to the quota management messaging layer for a quota management messaging session;
receiving at the quota management service, from the administrator portal application, notification of a tenant subscribing to a plan created by a hosting administrator, the plan comprising access to one or more resource provider services in a cloud computing infrastructure and specifying the proportion of the one or more resource provider services to be dedicated to the tenant plan subscription;
creating a subscription identifier for the tenant plan subscription;
routing via the quota management layer a first message to the administrator portal application of the subscription identifier for the tenant plan subscription; and
storing the subscription identifier for the tenant plan subscription and the resource provider services and proportion of the resource provider services dedicated to the tenant plan subscription.
receiving at the quota management service, from the administrator portal application, notification of changes to a plan type for the administrator, the changes comprising one or more of additional service quotas for one or more of the resource provider services (add-ons); and
updating, utilizing the quota management service, all tenant plan subscriptions for the plan type with the changes received by the administrator.

2. The media of claim 1, further comprising:
routing via the quota management layer a first message to a first resource provider service provider of the subscription identifier and the proportion of the first resource provider service to be dedicated to the tenant plan subscription; and
routing via the quota management layer a second message to a second resource provider service provider of the subscription identifier and the proportion of the second resource provider service to be dedicated to the tenant plan subscription.

3. The media of claim 1, further comprising:
receiving at the quota management service, from the administrator portal application, notification of changes to the add-ons, the changes comprising one or more of addition of service quotas to the add-ons for the plan type.

4. The media of claim 3, further comprising:
updating, utilizing the quota management service, all the add-ons for the plan type with the changes received by the administrator.

5. The media of claim 1, wherein the quota management layer comprises an administrator portal API (Application Program Interface) for the administrator portal application that corresponds to the quota management service.

6. The media of claim 7, wherein the quota management layer comprises a resource provider service API (Application Program Interface) for each of the resource provider services that correspond to the quota management service.

7. The media of claim 1, wherein the resource provider services comprise one or more virtual machines, data storage, web sites and text messages in a cloud-computing environment.

8. The media of claim 1, further comprising:
connecting a billing application to the quota management messaging layer for a quota management messaging session; and
routing via the quota management layer a billing message to the billing application administrator the subscription identifier for the tenant plan subscription and associated service quota information.

9. One or more computer storage media having computer-executable instructions embodied thereon that, when executed, perform a method for communicating via a quota management messaging session, the method comprising:
sending an initializing message for a quota management session from an administrator portal and to a quota management application, wherein the quota management session automatically pairs an administrator portal application and one or more resource provider services based on a quota management layer that facilitates communication between the administrator portal application and the one or more resource provider services;
receiving a tenant subscription notification at the quota management service from the administrator portal application, notification of a tenant subscribing to a plan created by a hosting administrator, the tenant subscription notification comprising tenant access to one or more resource provider services in a cloud computing infrastructure and specifying the proportion of the one or more resource provider services to be dedicated to the tenant plan subscription;
prior to routing the tenant subscription notification, creating a subscription identifier for the tenant plan subscription;
automatically routing the tenant plan subscription information to the one or more resource provider services; and
automatically routing the subscription identifier to the administrator portal application.

10. The media of claim 9, further comprising:
routing via the quota management layer a first message to a first resource provider service of the subscription identifier and the proportion of the first resource provider service to be dedicated to the tenant plan subscription; and
routing via the quota management layer a second message to a second resource provider service of the subscription identifier and the proportion of the second resource provider service to be dedicated to the tenant plan subscription.

11. The media of claim 10, further comprising:
receiving at the quota management service, from the administrator portal application, notification of changes to the tenant plan subscription, the changes comprising one or more of addition of resource provider services to the tenant plan subscription, deletion of tenant plan subscription.

12. The media of claim 11, further comprising:
routing via the quota management layer a third message to the first resource provider service of changes to the tenant plan subscription.

13. The media of claim 9, wherein the quota management layer comprises an administrator portal API (Application Program Interface) for the administrator portal application that corresponds to the quota management service.

14. The media of claim 13, wherein the quota management layer comprises a resource provider service API (Application Program Interface) for each of the resource provider services that correspond to the quota management service.

15. The media of claim 9, wherein the resource provider services comprise one or more virtual machines, data storage, websites and messaging service in a cloud-computing environment.

16. The media of claim 9, wherein the cloud-computing infrastructure is an enterprise data center.

17. One or more computer storage media having computer-executable instructions embodied thereon that, when executed, perform a method for managing resource provider service quotas and add-ons to the resource service quotas within a cloud-computing infrastructure, the method comprising:
receiving messages from an administrator portal application and resource provider services for a quota management messaging session between an administrator portal application and resource provider services, the quota management session automatically pairs the administrator portal application, the resource provider services and a quota management service based on a quota management messaging layer that facilitates communication between the administrator portal application, the resource provider services and the quota management service;
connecting the administrator portal application, the resource provider services and the quota management service to the quota management messaging layer for a quota management messaging session;
receiving at the quota management service, from the administrator portal application, notification of a tenant subscribing to a plan created by a hosting administrator, the plan comprising access to one or more resource provider services in a cloud computing infrastructure and specifying the proportion of the one or more resource provider services to be dedicated to the tenant plan subscription;
creating a subscription identifier for the tenant plan subscription;
routing via the quota management layer a first message to the administrator portal application of the subscription identifier for the tenant plan subscription; and
storing the subscription identifier for the tenant plan subscription and the resource provider services and proportion of the resource provider services dedicated to the tenant plan subscription.
routing via the quota management layer a first message to a first resource provider service provider of the subscription and the proportion of the first resource provider service to be dedicated to the tenant plan subscription;
routing via the quota management layer a second message to a second resource provider service provider of the subscription and the proportion of the second resource provider service to be dedicated to the tenant plan subscription.
receiving at the quota management service, from the administrator portal application, notification of additional service quotas for the resource provider services (add-ons) to the tenant plan subscription;
routing via the quota management layer a first change message to the first resource provider service provider of the subscription and the additional service quotas for the tenant plan subscription; and
routing via the quota management layer a second change message to the second resource provider service provider of the subscription and the additional service quotas for the tenant plan subscription.

18. The media of claim 17, wherein the quota management layer comprises an administrator portal API (Application Program Interface) for the administrator portal application that corresponds to the quota management service.

19. The media of claim 18, wherein the quota management layer comprises a resource provider service API (Application Program Interface) for each of the resource provider services that correspond to the quota management service.

20. The media of claim 19, further comprising:
connecting a billing application to the quota management messaging layer for a quota management messaging session; and
routing via the quota management layer a billing message to the billing application administrator the subscription identifier for the tenant plan subscription and associated service quota information.
